(19) United States
(12) Patent Application Publication
(10) Pub. No.: US 2023/0409617 A1
(43) Pub. Date: Dec. 21, 2023

(54) METHOD FOR PROVIDING TERM CONVERSION SERVICE

(71) Applicant: Suhyeon Sim, Busan (KR)

(72) Inventor: Suhyeon Sim, Busan (KR)

(21) Appl. No.: 17/842,281

(22) Filed: Jun. 16, 2022

(51) Int. Cl. G06F 16/33; G06F 21/16; G06F 16/338

(52) U.S. Cl. CPC G06F 16/3334; G06F 21/16; G06F 16/338; G06F 2221/0733

(57) ABSTRACT

The present invention relates to a method for providing a term conversion service, and more particularly, to a method for providing term conversion service for converting the terms described differently for each content producer into terms arbitrarily designated by a user and providing the same, thereby minimizing confusion caused by different terms for each content, inducing the user's interest in content, and stimulating content consumption.

### BACKGROUND OF THE INVENTION

### 1. Field of the Invention

The present invention relates to a method for providing a term conversion service, and more particularly, to a method for providing term conversion service for converting the terms described differently for each content producer into terms arbitrarily designated by a user and providing the same, thereby minimizing confusion caused by different terms for each content, inducing the user's interest in content, and stimulating content consumption.

### 2. Description of the Prior Art

With the development of Internet information society, millions of types of media contents are being produced worldwide every day. However, as media contents are mass-produced, there is a problem in that the terms specified in the contents are different for each media content producer, and thus it is difficult for users (consumers and subscribers) to identify whether the terms specified in the media contents mean the same term or not.

In addition, from the perspective of media content producers, it was difficult to determine the terms used in media contents produced by the creators in accordance with the circumstances of various users (consumers and subscribers).

Accordingly, in the existing content market, there was a problem in that content production and distribution were disrupted because the terms between content producers and users were different, and there were cases where users complained about the specified terms while consuming content.

Thus, content producers had to decide on a term that a large number of users can sympathize with, taking into account the views of various users, such as the user's religion, nationality, region of residence, occupation, gender, age, income level, taste and the like. Accordingly, there is an urgent need to develop a method for addressing the problems.

### SUMMARY

An object of the present invention is to provide a method for providing a term conversion service, and more particularly, to a method for providing a term conversion service for converting the terms described differently for each content producer into terms arbitrarily designated by a user and providing the same, thereby minimizing confusion caused by different terms for each content, inducing the user's interest in content, and stimulating content consumption.

To solve the above objects, there may be provided a method for providing a term conversion service, which is performed by a term conversion center, the method comprising: a term receiving step of receiving an initial term and a designated term to be used for term conversion from a user terminal; a subscription determination step of determining whether a user of the user terminal has subscribed to a term conversion service system or not by inquiring a term database; a data transmission step of transmitting a content containing a search word to be used for term conversion to a term conversion server, and transmitting an initial term and a designated term used for the term conversion from the term database to the term conversion server, when the user has subscribed to the term conversion service system; a term conversion step of causing the term conversion server to convert the initial term of the content into the designated term predetermined for the initial term; and a content display step of transmitting and displaying the content in which the initial term is converted into the user terminal.

In one embodiment of the present invention, implementation of the term conversion service for converting the initial term into the designated term may be selected in the term receiving step.

In one embodiment of the present invention, the initial term containing the search word and the designated term predetermined for the initial term may be transmitted to the term conversion server in the data transmission step.

In one embodiment of the present invention, in the term conversion step, the initial term containing the search word may be converted into the designated term, a separate name may be converted into the designated term, when the content containing the search word includes the separate name designated by the user, and the content may be watermarked to prevent copyright infringement, when the content is provided by a content producer subscribed to the term conversion service system.

In one embodiment of the present invention, the content with the initial term converted may be displayed on the user terminal without copy, paste, and print functions supported, so as to prevent copyright infringement, in the content display step.

According to one embodiment of the present invention, a term specified in the media contents provided through a user terminal can be converted into a term designated by a user and provided, thereby inducing the interest of users who are indifferent to various contents and expanding the supply and demand of content market, so as to provide the effect of increasing the consensus between content producers and users.

According to one embodiment of the present invention, an initial term can be converted into a term designated by a user, when the a user makes a request for changing the term in the middle of a content distribution process, thereby providing the effect of resolving user dissatisfaction.

According to one embodiment of the present invention, the user can take the content of which initial term is converted into the term designated by the user, and thus take the content of which initial term is converted into the term designated by the user, rather than the initial term specified by the producer, thereby improving user satisfaction and promoting content consumption.

According to one embodiment of the present invention, it can be possible to solve misunderstandings between content producers and users due to an expression of specified terms.

According to one embodiment of the present invention, when a user makes a request for providing content from a content producer who has entered into an agreement with a term conversion service system, the content can be provided by the term conversion service, thereby preventing copyright infringement, and allowing the content producer to specify terms more freely.

According to one embodiment of the present invention, the user's dissatisfaction with the terms of the content can be resolved, thereby increasing the demand for the content.

### BRIEF DESCRIPTION OF THE DRAWINGS

FIG. 1 shows a method for providing content according to a conventional system.

FIG. 2 shows a method for providing a term conversion service according to one embodiment of the present invention.

FIG. 3 shows a method for providing a term conversion service according to one embodiment of the present invention.

FIG. 4 shows components of a term conversion service system according to one embodiment of the present invention.

FIG. 5 shows a process of providing a term conversion service by a term conversion service system according to one embodiment of the present invention.

FIG. 6 shows content with an initial term converted by a term conversion service according to one embodiment of the present invention.

FIG. 7 shows a watermarked content according to one embodiment of the present invention.

FIG. 8 schematically shows an internal configuration of a computing device according to one embodiment of the present invention.

### DETAILED DESCRIPTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific illustrative aspects among one or more aspects. However, the aspects are merely illustrative, some of various ways among principles of the various aspects may be employed, and the descriptions set forth herein are intended to include all the various aspects and equivalents thereof.

In addition, various aspects and features will be presented by a system that may include a plurality of devices, components and/or modules or the like. It will also be understood and appreciated that various systems may include additional devices, components and/or modules or the like, and/or may not include all the devices, components, modules or the like recited with reference to the drawings.

The term “embodiment”, “example”, “aspect”, “exemplification”, or the like as used herein may not be construed in that an aspect or design set forth herein is preferable or advantageous than other aspects or designs. The terms ‘unit’, ‘component’, ‘module’, ‘system’, ‘interface’ or the like used in the following generally refer to a computer-related entity, and may refer to, for example, hardware, software, or a combination of hardware and software.

In addition, the terms “include” and/or “comprise” specify the presence of the corresponding feature and/or component, but do not preclude the possibility of the presence or addition of one or more other features, components or combinations thereof.

In addition, the terms including an ordinal number such as first and second may be used to describe various components, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In addition, in embodiments of the present invention, unless defined otherwise, all terms used herein including technical or scientific terms have the same meaning as commonly understood by those having ordinary skill in the art. Terms such as those defined in generally used dictionaries will be interpreted to have the meaning consistent with the meaning in the context of the related art, and will not be interpreted as an ideal or excessively formal meaning unless expressly defined in the embodiment of the present invention.

Prior to the detailed description of the present invention, “user” hereinafter may mean a consumer or subscriber of content, “content producer” may mean all producers who make media contents, “term” may mean objects expressed by names such as individuals, groups, animals, plants, natural environments, buildings, cities, and the like, “user terminal” may collectively refer to information and communication devices such as mobile phones, PCs, tablets, laptops, TVs and the like that support the Internet search function to search media contents, and “watermark” may mean an expression to distinguish from an initial original content, including a specific expression that a term conversion service has been performed on the work of the original content.

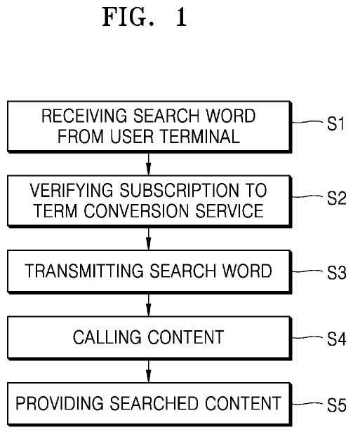

FIG. 1 shows a method for providing content according to a conventional system.

As shown in FIG. 1, in a conventional system, a process of providing content may include: inputting a search word by a user (S1), verifying subscription when user authentication is required (S2), transmitting the search word for which user authentication is completed (S3), calling the content containing the input search word (S4), and displaying the searched content on a user terminal 10 (S5).

As such, when the user inputs a search word through the user terminal, content containing the search word may be provided for each media.

As a result, in the conventional system, each user's environment is not considered, and thus the content is displayed on the user terminal 10 without a separate conversion process for terms.

In other words, the conventional system is a system centered on the content producer 13 without considering the user, and thus the user has no choice but to receive the searched content passively.

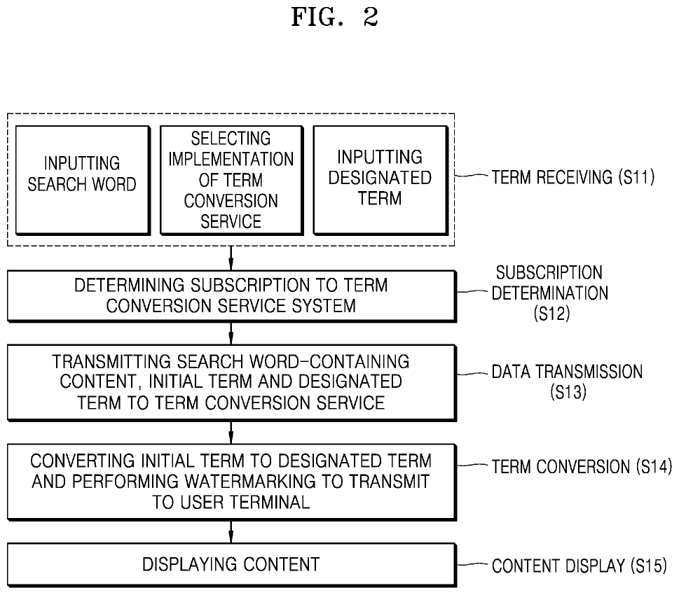

FIG. 2 shows a method for providing a term conversion service according to one embodiment of the present invention.

As shown in FIG. 2, a method for providing a term conversion service, which is performed by a term conversion center 11, may include: a term receiving step S11 of receiving an initial term and a designated term to be used for term conversion from a user terminal 10; a subscription determination step S12 of determining whether a user of the user terminal 10 has subscribed to a term conversion service system or not by inquiring a term database 15; a data transmission step S13 of transmitting a content containing a search word to be used for term conversion to a term conversion server 12, and transmitting an initial term and a designated term used for the term conversion from the term database 15 to the term conversion server 12, when the user has subscribed to the term conversion service system; a term conversion step S14 of causing the term conversion server 12 to convert the initial term of the content into the designated term predetermined for the initial term; and a content display step S15 of transmitting and displaying the content 20 in which the initial term is converted into the user terminal 10.

Specifically, in the data transmission step S13 of FIG. 2, the content provided by the content producer 13 who has signed an agreement with and subscribed to the term conversion service system may be stored in the content database 14, and when the user requests term conversion, the content containing the search word input by the user may be transmitted from the content database 14 to the term conversion server 12. In addition, when transmitting the content, the initial term and the designated term predetermined for the initial term may be transmitted together to the term conversion server 12.

Meanwhile, in the term conversion step S14, the term conversion server 12 may convert the separate name into the designated term when there are the initial term containing the search word and the separate name designated by the user in the corresponding content. Specifically, when the user inputs a separate name to be converted, the initial term containing the separate name and the search word may be converted into the designated term together.

In addition, the number of initial terms and designated terms is not limited, but may be determined differently for each user. Moreover, the designated term may be replaced at any time by the user.

Furthermore, in one embodiment of the present invention, watermarking may be performed on the content 20 with the initial term converted. Specifically, by watermarking the content 20 with the initial term converted, the user may recognize that the corresponding content is the content converted from the original content. In addition, a method for watermarking the content is not limited to any one, but may be implemented in various forms.

As a result, when the user inputs an initial term and a designated term in the term receiving step S11, the initial term included in the content may be converted into the designated term and displayed on the user terminal 10.

In addition, the content 20 with the initial term converted may be watermarked without copy, paste, and print functions supported, so as to enable the user to distinguish the corresponding content from the original content, thereby preventing copyright infringement.

As a result, when the user who has subscribed to the term conversion service system inputs an initial term and a designated term into an input window where an initial term and a designated term can be input, both terms may be stored in the term database and the content of the content producer 13 who has subscribed to the term conversion service system may be automatically subjected to the term conversion service and provided to the user, unless the term conversion service is canceled by the user.

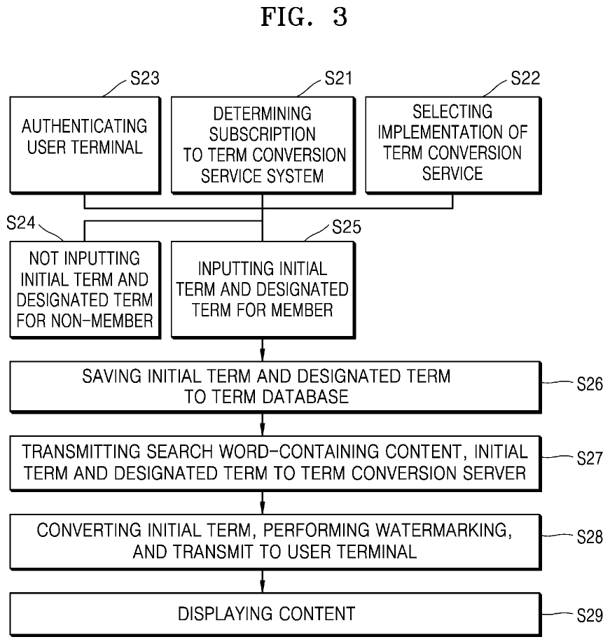

FIG. 3 shows a method for providing a term conversion service according to one embodiment of the present invention.

In S21, when the user accesses the term conversion service system through the user terminal 10 and searches for content by entering an initial term and a designated term, whether the user is one subscribed to the term conversion service system or not may be verified.

In step S22, the user may be allowed to select whether to implement the term conversion service or not. In other words, the user may directly select whether to convert the initial term of the content into the designated term.

In S23, an authentication procedure for identification of the user, etc., may be performed. Specifically, the term conversion service may not be provided to an unverified user terminal by checking whether the user terminal is a terminal of a user who has subscribed to the term conversion service system or not. Preferably, the authentication procedure for the user may be performed by inquiring the personal identification information provided by the user at the time of membership registration.

In S24, when the user is a non-member who has not subscribed to the term conversion service system, the user may not input the initial term and the designated term, and thus the term conversion service may not be available. In other words, users who has not subscribed to the term conversion service may not receive content, and thus it may be possible to prevent copyright infringement by preventing any third parties from unauthorized distribution of content.

In S25, when the user is a member who has subscribed to the term conversion service system, the user may be allowed to input the initial term and the designated term. In addition, the user may arbitrarily change and input the initial term and the designated term. In addition, the term conversion service may be performed with the designated term which has been most recently changed by the user.

In S26, the initial term and the designated term input by the user may be stored in the term database 15.

In S27, the content provided by the content producer 13 who has subscribed to the term conversion service system may be transmitted from the content database 14 to the term conversion server 12, and the initial term and designated term input by the user may be transmitted from the term database 15 to the term conversion server 12. Specifically, the content of the content producer 13 who has not subscribed to the term conversion service system may not be provided to the user, thereby preventing copyright infringement.

In S28, the initial term included in the content transmitted to the term conversion server 12 may be converted into the designated term, and the content 20 in which the initial term is converted may be watermarked and transmitted to the user terminal By performing watermark processing on the content 20 in which the initial term is converted as described above, the original content may be distinguished from the content 20 in which the initial term is converted, so as to prevent copyright infringement.

In S29, the content 20 in which the initial term is converted may be displayed on the user terminal 10. In addition, the copy, paste, and print functions may not be supported in displaying content on the user terminal 10, and thus copyright infringement may be prevented.

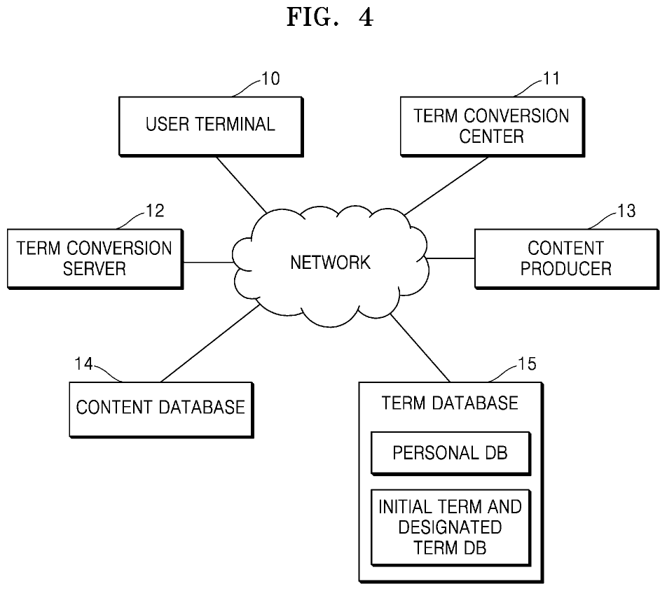

FIG. 4 shows components of a term conversion service system according to one embodiment of the present invention.

In the conventional system, the user may access the web browser provided by the term conversion center 11 through the user terminal 10 and receive normal content provided by the web browser. Specifically, in the conventional system, the content of the content producer 13 who has not subscribe to the term conversion service system may also be provided to the user terminal 10.

Meanwhile, in the term conversion service system shown in FIG. 4, a user who has subscribed to the term conversion service system may access the web browser provided by the term conversion center 11 through the user terminal 10 and input a search word.

The term conversion center 11 may store the contents of the content producer 13 who has subscribed to the term conversion service system in the content database 14.

In addition, the term conversion center 11 may transmit the content containing the search word from the content database 14 to the term conversion server 12 when the search word is input in the user terminal 10 to make a request for term conversion.

Alternatively, the term conversion center 11 may access the web page of the content producer 13 through the Internet network and transmit the content containing the search word to the term conversion server 12. Specifically, the above process may be performed when the term conversion center 11 does not receive the corresponding content from the content producer 13.

In addition, the term conversion center 11 may transmit the initial term and designated term input by the user from the term database 15 to the term conversion server 12.

The term conversion server 12 may convert the initial term included in the content into the designated term, perform watermark processing on the content, and transmit to the user terminal 10 through the Internet network.

The user terminal 10 may display the content 20 in which the initial term received from the term conversion server 12 is converted.

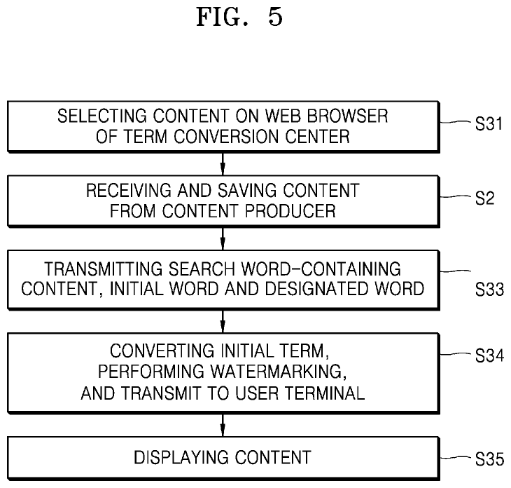

FIG. 5 shows a process of providing a term conversion service by a term conversion service system according to one embodiment of the present invention.

In S31, the user terminal 10 may access the web page provided by the term conversion center 11 and search for content by inputting a search word.

In S32, the content may be provided from the content producer 13 who has subscribed to the term conversion service system.

In S33, the content may be stored in the content database 14. In addition, when a search word is input in the user terminal 10 to make a request for term conversion, the content containing the search word may be transmitted from the content database 14 to the term conversion server 12 or the content containing the search word may be transmitted to the term conversion server 12 by accessing the web page of the content producer 13 through the Internet network. In addition, the initial term and the designated term stored in the term database 15 by the user's input may be transmitted to the term conversion server 12.

In S34, the initial term included in the content transmitted to the term conversion server 12 may be converted into the designated term predetermined for the initial term, and watermark processing may be performed on the content. In addition, the content 20 in which the initial term has been converted as such may be transmitted to the user terminal 10.

In S35, the content 20 with the initial term converted may be displayed on the user terminal 10.

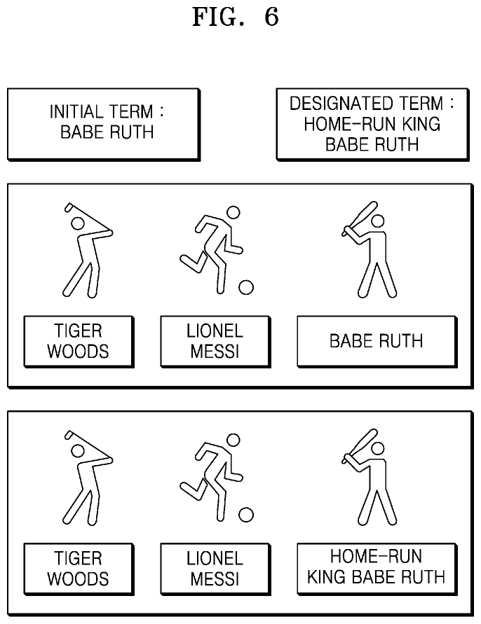

FIG. 6 shows content with an initial term converted by a term conversion service according to one embodiment of the present invention.

As shown in (a) of FIG. 6, the user may input an initial term and a designated term in the form of “initial term: Babe Ruth,” “designated term: Home-run king Babe Ruth through the user terminal 10.

(b) of FIG. 6 shows one example displayed on the user terminal 10 when content is searched for in a conventional system.

As shown in (c) of FIG. 6, according to one embodiment of the present invention, a search result in which an initial term is converted into a designated term through the converting may be displayed on the user terminal 10.

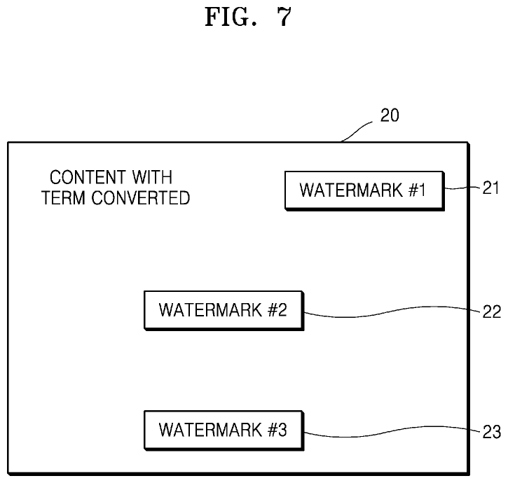

FIG. 7 shows a watermarked content according to one embodiment of the present invention.

As shown in FIG. 7, the content 20 with the initial term converted may be displayed on the user terminal 10, and the content 20 with the initial term converted may be watermarked. Specifically, watermarks 21, 22 and 23 may be marked on the top, center, and bottom of the content 20 with the initial term converted. In addition, the watermark may be expressed in various ways to express that the corresponding content is the content 20 in which the initial terms are converted from the original content, such as a position of the mark, a size of the mark, a method of using the initial term of the content, a language used, and the like.

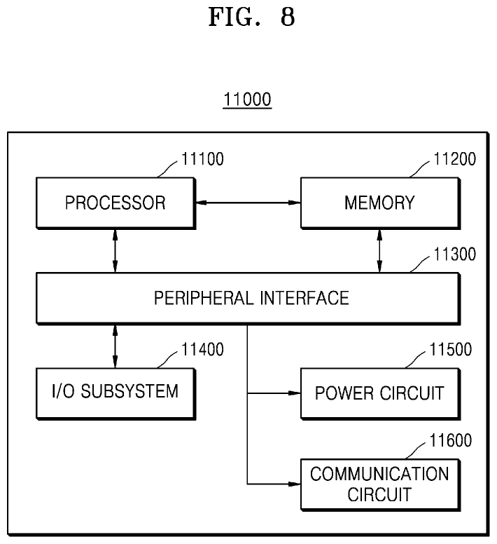

FIG. 8 schematically shows internal components of the computing device according to one embodiment of the present invention.

The computing device 1000 shown in the above-described FIG. 4 may include components of the computing device 11000 shown in FIG. 8.

As shown in FIG. 8, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to the computing device 1000 shown in FIG. 4.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 8 is merely an example of the computing device 11000, and the computing device 11000 may have a configuration or arrangement in which some components shown in FIG. 8 are omitted, additional components not shown in FIG. 10 are further provided, or at least two components are combined. For example, a computing device for a communication terminal in a mobile environment may further include a touch screen, a sensor or the like in addition to the components shown in FIG. 8, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vise versa.

According to one embodiment of the present invention, the work is segmented into a plurality of zones, and the zones segmented on the work are assigned a plurality of workers to allow the workers to perform tasks for one work, so that the task can be rapidly performed.

According to one embodiment of the present invention, a task may be performed on an object having a part included in a specific zone and a remainder deviating from the specific zone based on a boundary rule, so that the worker performing task on a specific zone of the work can be prevented from missing a task on an object located over a plurality of boundaries of the work.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A method for providing a term conversion service, which is performed by a term conversion center comprising at least one processor and at least one memory, the method comprising:
a term receiving step of receiving an initial term and a designated term to be used for term conversion from a user terminal;
a subscription determination step of determining whether a user of the user terminal has subscribed to a term conversion service system or not by inquiring a term database;
a data transmission step of transmitting a content containing a search word to be used for term conversion to a term conversion server, and transmitting an initial term and a designated term used for the term conversion from the term database to the term conversion server, when the user has subscribed to the term conversion service system;
a term conversion step of causing the term conversion server to convert the initial term of the content into the designated term predetermined for the initial term; and
a content display step of transmitting and displaying the content in which the initial term is converted into the user terminal.

2. The method of claim 1, wherein implementation of the term conversion service for converting the initial term into the designated term is selected in the term receiving step.

3. The method of claim 1, wherein the initial term containing the search word and the designated term predetermined for the initial term is transmitted to the term conversion server in the data transmission step.

4. The method of claim 1, wherein the initial term containing the search word is converted into the designated term,
a separate name is converted into the designated term, when the content containing the search word includes the separate name designated by the user,
and the content is watermarked to prevent copyright infringement, when the content is provided by a content producer subscribed to the term conversion service system in the term conversion step.

5. The method of claim 1, wherein the content with the initial term converted is displayed on the user terminal without copy, paste, and print functions supported, so as to prevent copyright infringement, in the content display step.
